(19) United States
(12) Patent Application Publication
(10) Pub. No.: US 2024/0198828 A1
(43) Pub. Date: Jun. 20, 2024

(54) ELECTRICAL CHARGING STORAGE DEVICE

(71) Applicant: Ampicity, Inc., Cornelius, NC (US)

(72) Inventors: Peter Bakema, Detroit, MI (US); Brad Bakema, Belle River (CA); Kyle Vos Strache, Gladwyne, PA (US)

(21) Appl. No.: 18/538,683

(22) Filed: Dec. 13, 2023

Related U.S. Application Data
(60) Provisional application No. 63/387,413, filed on Dec. 14, 2022.

(51) Int. Cl. B60L 53/31; B60L 53/126; B60L 53/51; B60L 53/67; B60L 53/80

(52) U.S. Cl. CPC B60L 53/31; B60L 53/126; B60L 53/51; B60L 53/67; B60L 53/80

(57) ABSTRACT

An electrified vehicle (EV) charging device comprising a support structure, the support structure defined to receiving within an opening in the support structure at least one electrical storage device; the support structure further comprising a display unit and a charging wire suitable for attaching to a port on an EV for providing charge from the electrical storage device to the EV; and the support structure comprising an aesthetic exterior.

### CROSS-REFERENCE TO RELATED APPLICATIONS

This application claims the benefit of U.S. Provisional Patent Application No. 63/387,413 filed on Dec. 14, 2022, with the United States Patent and Trademark Office, the contents of which are incorporated herein by reference in their entirety.

### FIELD OF THE INVENTION

The invention is related to devices for storage of electrical charge and discharge, preferably for charging of electrical vehicles, and systems for identifying and measuring charge within a device, and systems for securing devices in a given location.

### BACKGROUND OF THE INVENTION

The rapid growth of the electrical vehicle (EV) within the United States and worldwide is changing the way in which consumers must utilize service stations (for providing gasoline or diesel) and the way in which consumers obtain charge for their EV.

As of 2022, the EV market remains a small percentage of the entire number of vehicles on the road. However, the growth is expected to exponentially grow over the next few years, and it is possible that the percentage of EV vehicles surpasses that of gasoline- or diesel-based vehicles within the next 10 years. Notably, some states are already pushing measures to eliminate the sale of gasoline or diesel vehicles by 2030. While the market for secondhand vehicles will remain for some time and it is possible that gasoline or diesel vehicles will always remain, there are significant hurdles ahead for the expansion of the EV on the road.

One of these key issues is the prevalence of EV charging stations and, to a further extent, simply an expansion of the number of charging stations as a whole. This is due in part to the fact that EV charging does not occur as rapidly as pouring a gallon or 10 gallons of gasoline, which is necessary in gasoline-based vehicles. A key growth metric is the prevalence of rapid charging, or level 3 charging stations, able to use 480-volt or higher DC. These devices are able to provide an average of 100 miles of charge per hour or higher. Presently, as of 2021, the quantity of level 3 charging stations was essentially limited to the largest states and metros, with approximately 20,000 level 3 charging stations in California, as well as approximately 6,000 in Florida and under 800 in each of Texas, New York, and Washington, with other states having fewer level 3 charging stations. A key issue with such stations is that they must be connected to specialty wiring and the space and power necessary for these stations makes their use limited to certain locations, which hinders efficient travel and charging. Finally, these stations often cost upwards of $50,000 for a home installation and closer to $300,000 for commercial installations that may contain several individual plugs for charging.

What is needed are new devices suitable for creating charging at a greater number of locations and where infrastructure is unavailable for attaching level 3 and similar stations into a power grid. Applicant has created a novel device and system to allow for a rapid growth in high capacity (level 2, level 3, or higher charging) devices as EV expansion continues and systems for securing the same for easy charge or replacement of batteries within the device systems.

### SUMMARY OF THE INVENTION

In a preferred embodiment, an EV charging device comprising a support structure, said support structure defined to receiving within an opening in the support structure at least one electrical storage device; said support structure further comprising a display unit and a charging wire suitable for attaching to a port on an EV for providing charge from the electrical storage device to the EV; said support structure comprising an aesthetic exterior.

In a further embodiment, the EV charging device wherein the aesthetic exterior is selected from the group consisting of: a tree, a hedge, a vegetative display, and combinations thereof.

In a further embodiment, the EV charging device wherein the aesthetic exterior comprises a charging element, such as a solar panel or wind turbines to charge the electrical store device of the charging device.

In a further embodiment, the EV charging device further comprising a support base.

In a further embodiment, the EV charging device wherein the support base further comprises an aperture.

In a further embodiment, the EV charging device further comprising wherein the support structure comprises a structure aperture which is aligned with the aperture and wherein each are defined to receive a fastener to secure said support base to the ground.

In a further embodiment, the EV charging device wherein the fastener comprises an anchor space which defines a space between the support base and a head of the fastener and wherein the structure aperture receives the head and secures thereto the charging device to the support base.

In a further embodiment, the EV device further comprising a wireless connectivity element.

In a further embodiment, the EV device further comprising a controller suitable for communicating between the electrical storage and an EV.

In a further embodiment, the EV device further comprising at least one fastener engaging to a base and to a ground surface, said charging device separately connected to said base.

In a further embodiment, the EV device further comprising at least one fastener engaging to a base and to a ground surface and wherein the aperture within the base aligns with a second aperture within the electrical storage device (housing); wherein a single fastener is suitable for securing the electrical storage device to said base and into a surface.

In a preferred embodiment, a system for charging an EV comprising a device of any of the prior embodiments and a home unit wherein the charging device communicates with the home unit so as to enable communication between the charging device and the home unit and a network.

In a preferred embodiment, an electrified vehicle (EV) charging device comprising a support structure, said support structure defined to receive at least one electrical storage device within an opening in the support structure, said support structure further comprising a display unit and a charging wire, said charging wire configured for attaching to a port on an EV for providing charge from the electrical storage device to the EV.

In a further embodiment, the EV charging device wherein said support structure comprises an aesthetic exterior. In a further embodiment, the EV charging device wherein the aesthetic exterior is selected from the group consisting of: a tree, a hedge, a vegetative display, and combinations thereof. In a further embodiment, the EV charging device wherein the aesthetic exterior comprises a charging element selected from a photoelectric panel and a turbine.

In a further embodiment, the EV charging device further comprising a support base comprising an aperture. In a further embodiment, the EV charging device further comprising wherein the support structure comprises a structure aperture which is aligned with the aperture within the support base, wherein the structure aperture and the aperture within the support base are configured to receive a fastener to secure said support base to a ground surface by having a head of the fastener on a first side of the aperture and a shaft portion of the fastener passing through both of the aperture within the support base and the structure aperture, said shaft portion to be received within a substrate below the support structure. In a further embodiment, the EV charging device wherein the fastener comprises an anchor space which defines a space between the support base and a head of the fastener and wherein the structure aperture receives the head and secures the charging device to the support base. In a further embodiment, the EV charging device further comprising a locking member positioned within the support base wherein the locking member is configured to engage to the fastener. In a further embodiment, the EV charging device wherein the locking member is configured to engage to the head of the fastener.

In a further embodiment, the EV charging device further comprising a wireless connectivity element, a processor, and software sufficient to provide a connection between the EV charging device and a battery in an EV.

In a further embodiment, the EV charging device further comprising at least one fastener engaging to a base and to a ground surface, said EV charging device separately connected to said base.

In a further embodiment, the EV charging device comprising a base and a fastener, said base having a top side, a bottom side, and one aperture disposed of between said top side and said bottom side, said top side of said base contacting the EV charging device and the bottom side of the base in contact with a ground surface, wherein the aperture within the base aligns with a second aperture within the support structure, and wherein a single fastener is suitable for securing the EV charging device to said base and into a surface.

In a preferred embodiment, a system for charging an electrified vehicle (EV) with a wireless EV charging device, said wireless EV charging device comprising: (a) at least one battery, a housing surrounding the at least one battery, a wireless transceiver, and a processor suitable for operating software and the wireless transceiver; (b) said wireless EV charging device having a known GPS location and defining a kilowatt-hours of electricity stored within the at least one battery; (c) a network, said network defining the GPS location of said wireless EV charging device; (d) the network defining the total amount of charge remaining within the system at the wireless EV charging device at the particular GPS location; and (e) the system operating said software to perform the following steps: (i) receiving a request for a charge of an EV; (ii) defining the amount of charge desired for the EV; (iii) identifying the closest wireless EV charging device having the charging capacity for the EV; and (iv) providing a GPS location for the wireless EV charging device having capacity for the EV.

In a further embodiment, the system further comprising transmitting stored power from the EV charging device to the EV.

In a preferred embodiment, an electrified vehicle (EV) charging device, said EV charging device comprising: a support structure having a void defined therein; at least one battery positioned within the void; the support structure having a base end and a top end; a decorative feature positioned on said top end and a support base positioned on said base end; and a lifting anchor configured to the at least one battery.

In a further embodiment, the EV charging device wherein the lifting anchor comprises a threaded fastener at one end.

In a further embodiment, the EV charging device wherein the lifting anchor is defined with a threaded fastener at one end of the lifting anchor. In a further embodiment, the EV charging device wherein the threaded fastener passes through an aperture within the support base. In a further embodiment, the EV charging device wherein removal of the at least one battery is defined by rotating the threaded fastener. In a further embodiment, the EV charging device wherein removal of the at least one battery is performed by rotating the at least one lifting anchor, removing the at least one battery, and replacing the at least one battery with a second battery.

### BRIEF DESCRIPTION OF THE FIGURES

FIG. 1 depicts an EV charging device as a tree.

FIG. 2 depicts an EV charging device as an ornamental arrangement.

FIG. 3 depicts batteries being stacked within an EV charging device.

FIG. 4 depicts several EV charging devices stacked on a base.

FIG. 5 depicts an anchor system for securing a base plate and an EV charging device to the ground.

FIG. 6 depicts a system of EV charging devices and connecting with a home base.

FIGS. 7A, 7B, and 7C depict a hedge EV charging device.

### DETAILED DESCRIPTION OF THE INVENTION

The present embodiments detail devices, systems and methods that are suitable for charging of an electrified vehicle (EV). EV charging is a major roadblock to the expansion of the EV market. A critical issue is that rapid charging stations, e.g., a level 3 charging station, are frequently only available on major thoroughfares, and even then only in the largest metropolitan areas. Of course, this is due in part to the lack of EVs located outside of these sectors. However, with the expected growth of the EV market over the next 10 years, and even the next two years, a growth of EV charging stations must be available to service these vehicles and allow for greater penetration of EV into the car industry.

However, an ordinary business seeking to provide level 3 charging will find significant roadblocks to the installation of such a system. For example, many municipalities have strict rules and regulations regarding such stations because of the infrastructure required and the level of electricity and power lines running into these stations. This also requires significant space to hold and store the devices and the power equipment necessary for creating these stations. This requires the approval of the landowner (not always the same person who desires the installation of the charging stations), permits, and a significant cost. Indeed, many of these level 3 charging stations, for even as few as four level 3 charging devices, may be $300,000 or more for commercial settings. This is a significant upfront cost that may be difficult for many business owners to swallow to meet customer needs and which may not yield a significant return on investment, thus preventing their widespread adoption.

Even where permits and funds are available to the business owner, a time issue remains in that time from seeking permits to breaking ground averages nine months for installation of such charging systems. For many businesses, this is too slow when customer needs are being factored into these installations. Finally, even where the money, permits, land, and time are not hurdles, the generation of power to a given location may be a significant impediment to the installation due to the high-voltage requirements. Otherwise, installation may be able to occur only in a few set of locations, and that location may not be desirable for the business or municipality or any owner of the charging station to serve their customers. Indeed, in many cases current installations are at the farthest portion of a parking lot so as to reach power grids and to allow for storage of the necessary power generation devices away from traffic. This creates an inefficiency in charging and use of charging systems, leading to low profitability and thus low desire to install chargers that will not return a profit.

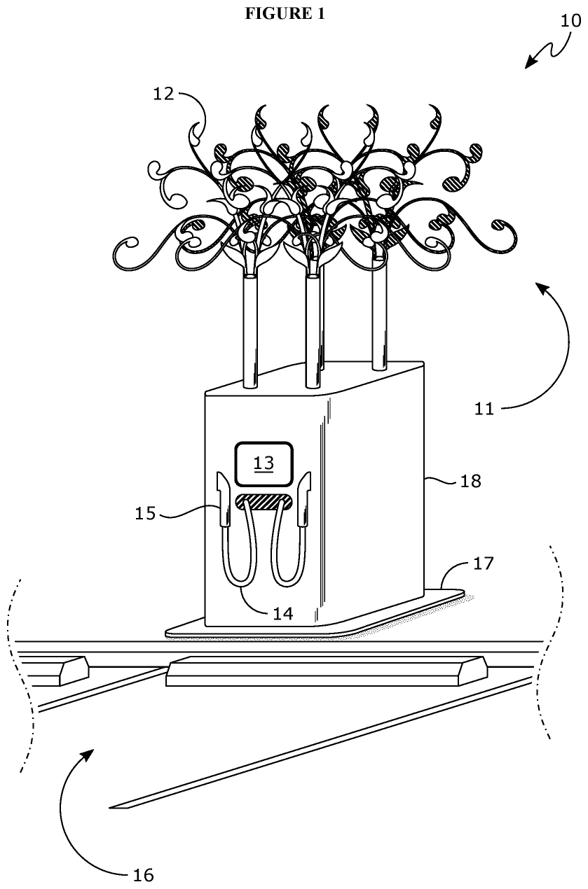

A clear solution is needed and is provided by the following disclosed devices. In view of FIG. 1, an electrical charging device (10) is depicted. The Electrical charging device (10) comprises a support structure (18) which may take a number of different forms. Preferably, the support structure (18) provides for a shell to store within the support structure (18) one or more electrical discharge elements such as a battery or capacitor. Furthermore, the support structure (18) should provide sufficient stability such as with an attached support base (17). The support base (17) may simply be a base to allow for a more stable element, or preferably, may add some additional weight and mass to aid in theft prevention, such as a 1″ steel plate such as those frequently found in road construction. The top of the charging device (10) comprises an ornamental design element, here depicted as a tree structure (11) which provides at a minimum an aesthetic portion to the device, much like the imitation trees of cellphone towers. Here, the tree structure (11) contains leaves (12) which may be for aesthetic design and/or the tree or hedge can include power generation tools. For example, leaves (12) on the structure may themselves aid in the charging of the stored electricity by including a solar panel or a miniature wind powered generator which may freely move with the wind to add charge to the device. For example, each of the leaves can be a solar panel or could be miniature wind turbines. These allow for constant trickle charging of the device either to run the electronics or to charge the batteries. In each case, these allow for charging of the electrical device in a passive manner.

Attached to the support structure (18) is a display unit (13), and further extending therefore, whether from the support structure (18) or the display unit (13), are charging wires (14) and a charging plug (15). The charging device (18) is positioned adjacent to a parking space (16), here depicted as two parking spaces. This allows for a single charging device (10) to be accessed by at least the two parking spots directly in front of the charging device (10), but access is not so limited. It is further possible that parking spots may be adjacent to or behind the charging device (10) and thus accessible by other parking spots as well.

Within the charging device (10) are provided at least one but preferably a plurality of electrical storage devices. Most notably, such electrical storage devices are batteries, however, other forms may be suitable, such as capacitors. Other such devices may also be utilized as known to those of ordinary skill in the art. The purpose of the charging device (10) and of the support structure (18) is the safe storage of the electrical storage devices and allowance for a discharge of electricity stored therein into an EV for purchase by a customer.

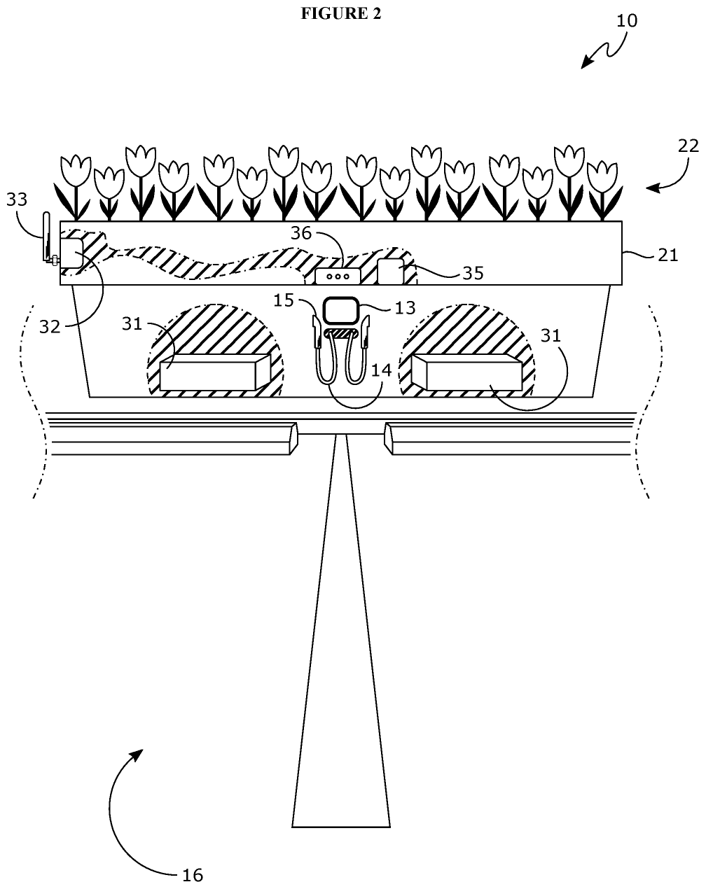

FIG. 2 thus shows the positioning of electrical storage device (31) within a charging device (10). Herein a planter structure (21) is utilized with the same purpose as the support structure (18) of FIG. 1, namely the containment of the electrical storage device (31). However, instead of a tree structure, the ornamental features are depicted as a flower structure (22), not shown to size or scale, can be added. Thus, the top of the planter structure (21) could have soil and be planted with real flowers or could utilize plastic or imitation flowers to provide an appropriate design for the particular location. Thus, seasonal flowers or greenery suitable for the particular location can be interchanged as desirable. The planter structure (21) thus, like the support structure (18), serves as the storage location for the electrical storage devices (31), such as a plurality of batteries. Furthermore, power generating elements, such as or analogous to the leaves (12) of FIG. 1, can be included, such as turbines, solar panels, etc., to provide passive charging. The planter structure (21) then, like the support structure (18), contains a display unit (13) and charging wires (14) to the plug (15) for charging of a vehicle.

The planter structure (21) further provides for a wireless communication device (32) and an antenna (33). Those of ordinary skill in the art recognize that communication between a first device and another device and allow for transmission of data between the two devices, such as wherein the wireless communication device (32) is a transceiver sufficient to transmit and receive data. For example, the electric storage devices (31) can work with a controller (35), which may be any suitable computer device, allowing for the running of suitable software and allowing for receipt of and processing of information necessary to operate the planter structure device (21) for its intended purpose, such as for charging an EV. Such a device may further comprise any amount of storage, memory, and/or processor(s), as well as communication devices for local and remote communication and connection to the World Wide Web, as nonlimiting examples. An off-the-shelf computer currently available in 2022 would be a nonlimiting example of a suitable computer to function as the controller having sufficient processing power, storage, and communication tools, such as a transceiver, to enable the running of software, storage of information in a local or remote database, communication with one or more additional devices, or processing of payments, among nonlimiting features of the device.

Thus, the controller (35) can work with one or more sensors (36) that allow for detection of a vehicle that is seeking to charge at the location. Furthermore, the controller (35) can perform a number of tasks to enable performance and operation of the charging device (10). In one embodiment, the charging device (10) can determine how much charge is remaining to be provided to a user. This information can be transmitted, for example with the communication device (32) and provided to the World Wide Web or to another communication platform that would allow a user to identify the precise location of the charging device (10), such as via a known GPS location or a GPS location being transmitted from the charging device (10). Furthermore, the total amount of charge remaining to be given can be provided. For example, the charging device (10) may possess a total of 400 kW·h that can be discharged to any number of users. At a given moment, that number can increase (if being charged) or can decrease if a user is charging an EV from the charging device (10). Thus, if a user has a vehicle and desires a full charge, such as 70 kW·h, then the user can determine if 70 kW·h are remaining at the charging device (10) to suitably fill the user's EV. A user can access an app on their phone, or access via a Web site, a map-based GUI that displays and/or identifies available charging systems, their available charge, their cost per kW·h, directions to the location, and other features to aid users in identifying a device having sufficient capacity to meet the user's needs for their EV.

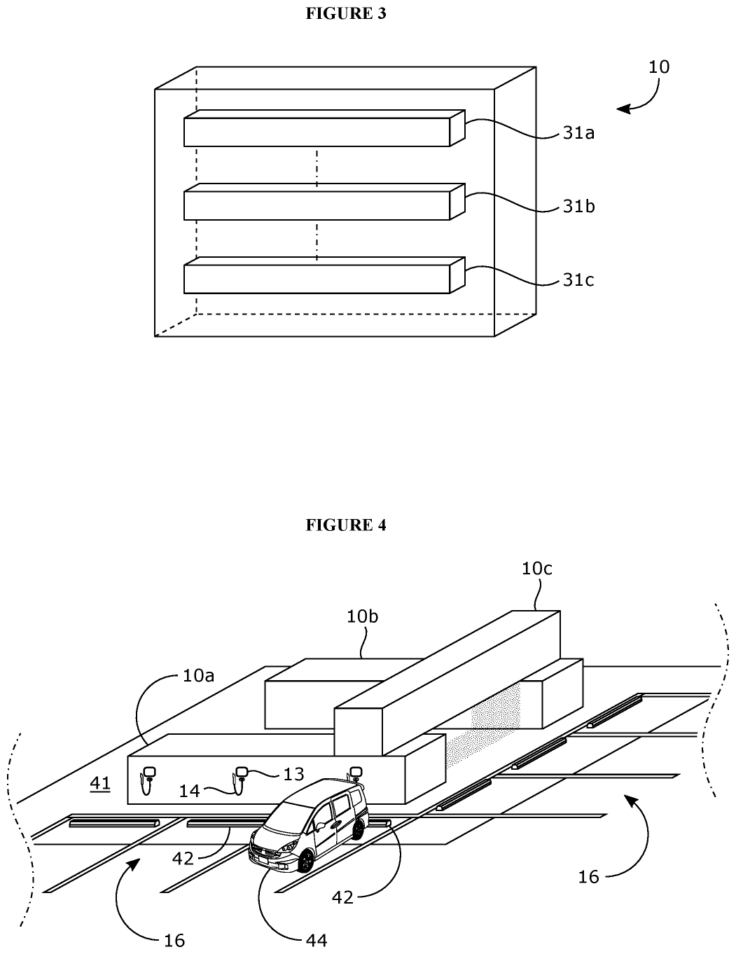

FIG. 3 depicts an internal portion of the charging device (10) and the presence of three electric storage devices (31a, 31b, and 31c). Here, let us call these batteries, and they can be stacked on one another to create a parallel charge, thus creating greater capacity. This increases the amp hour capacity of the devices. This is important for a number of reasons. First, the shape and size of the batteries can be modified to allow for the maximum space to fill the void within the charging device (10). This frequently occurs in small devices such as mobile phones and laptops, which have irregular shaped batteries to maximize capacity within the space. The same may occur with the charging device (10), to ensure that the space can maximize the battery amp hours.

In further embodiments, however, the amp hours can simply be increased or decreased as necessary. For example, a charging device (10) typically uses only 300 kW·h over the course of a week, and the batteries are charged or replaced as needed by a servicing entity, which is able to charge the batteries, or swap them out, with fully charged batteries twice a week, such as on Sunday and Wednesday. Thus, at any given moment, typically only 200 kW·h might be necessary, and that would allow for a charging device (10) of a particular size to store that number of batteries. However, another location typically uses 1,200 kW·h per week, and thus would need significantly more battery storage or more frequent charging or changing of the batteries in the device. This can also be achieved by increasing the number of batteries stacked within the charging device (10) or by adding a second charging device (10) in proximity to the first to meet the demand.

As depicted in FIG. 3 the batteries can be stacked in a vertical manner. However, the stacking can be performed in parallel, such as side-by-side, on top of one another, or even perpendicular to one another creating layers of stacked batteries. In all cases, the batteries need to be accessible for charging, quick replacement, or both.

However, as depicted in FIG. 4, multiple charging devices (10) can also be stacked together. Shown are two charging devices (10a and 10b) on the bottom and one charging device (10c) on a second layer perpendicular to the other two. Thus, where the capacity of a charging device (10) is not sufficient for the space, while the addition of more batteries such as in FIG. 3 is suitable, and so too is an option to stack charging devices (each with their own amp-hour capacity) to allow for either an increase in the total amp hour capacity of the location (here 3 times that of just a single charging device) but may also allow for an increase in the number of charging wires (14). This would allow for the feature as depicted in FIG. 4 to be spaced adjacent to multiple parking spots, as a nonlimiting example of its use.

FIG. 4 also depicts a parking anchor (41), which is intended as a flat element. The charging devices (10) are preferably attached to the parking anchor (41). This can extend beyond the charging devices (10) and, for example, be driven on by an EV (44) who is parking to engaging with the charging device (10). The parking anchor (41) thus may further contain a sensor to determine if a weight is positioned on the parking anchor (41), thereby identifying the presence of a vehicle (44), as a nonlimiting example of a sensor. Other sensors may include motion sensors, heat sensors, proximity sensors, video cameras, infrared cameras, etc., as nonlimiting examples. Parking chocks (42) may also be provided to prevent damage to the charging device (10), and these may be further anchored to the parking anchor (41) and can be as simple as a parking stop or be more substantial vertical stops to prevent contact with the charging device (10). Thus, by providing a sensor, the charging device (10) can detect the presence of an EV (44) and engage with the vehicle to aid the user in charging the EV (44).

FIG. 5 provides for a further feature regarding securing the charging device (10) at a given location. Security is necessary for a few reasons, the first being to prevent theft of the device as a whole. The second is to allow for anchoring of the device to prevent damage if it was accidentally or purposefully being destroyed. Thus, FIG. 5 depicts an anchor plate (51). The particular dimensions of the anchor plate (51) are not material, and it may actually be smaller or larger than the charging device (10), though it is shown dramatically larger than the charging device (10) in FIG. 5. A threaded anchor (52) is provided, which may be inserted through an aperture (57) in the anchor plate (51). A head (55) allows for a tool to rotate the threaded anchor (52) and to insert it into the ground. Such dimensions may include a threaded anchor (52) of between 6 inches and several feet. The longer and more substantial diameter of the threaded anchor (52) the greater force will be provided to retain it in place in the ground, thus aiding in securing the device.

While the threaded anchor (52) may simply function as a screw and pass first through the device aperture (54) in the charging device (10), where the dimensions of the head (55) are larger than the device aperture (54), and then passing through the anchor plate (51) aperture (57) and into the ground (56). This secures both the charging device to the anchor plate (51) and also to the ground (56). Alternatively, an anchor space (53) is provided between the top of the anchor plate (51) and the head (55) to allow for the insertion of the head into the device aperture (54) and to allow the anchor plate (51) to be first installed into the ground and then the charging device (10) to be secured on the anchor space (53).

In certain embodiments, the charging device contains a locking element that allows for securing the charging device to the anchor plate (51) by locking to, for example, the threaded anchor (52). For example, the corresponding locking element (58) may be utilized with the head (55) and the charging device (10) and can allow for fast removal of the charging device (10) such as with a specialized tool while leaving the threaded anchor (52) and the anchor plate (51) installed into the ground. The locking element (58) may slide, rotate, latch, or secure to the threaded anchor (52) or to the anchor plate (51) as would be understood by one of ordinary skill in the art. Such a feature specifically aids in the prevention of theft, and a unique tool, for example, can allow for access or unlocking of the locking element (58) to allow for both ease of use by one authorized to unlock the locking element (58) but also prevent or reduce the chances of theft for unauthorized access.

The feature of using an anchor (52) allows for a unique way to secure the charging device (10) to a location. This can aid in preventing theft, for example, of the batteries within the charging device (10). However, such features may also hinder efficient removal of, replacement of, or access to the batteries in the charging device (10). A feature of the charging devices of the present disclosure is that they can be easily removed from the charging device (10). This allows for replacement batteries to be installed, specifically ones that have more charge than the batteries being replaced. Thus, a feature of the present disclosure is allowing for rapid removal of the batteries or the device as a whole by using an ingenious anchor system that penetrates into the ground, through an anchor plate (51) all with a single anchor (52), thus allowing for securing to a location and also access by removal or rotation of a single element. This greatly increases the efficiency of access and removal of drained batteries in order to replace them with batteries having more charge, thus allowing for faster replacement and management of multiple charging devices within a community.

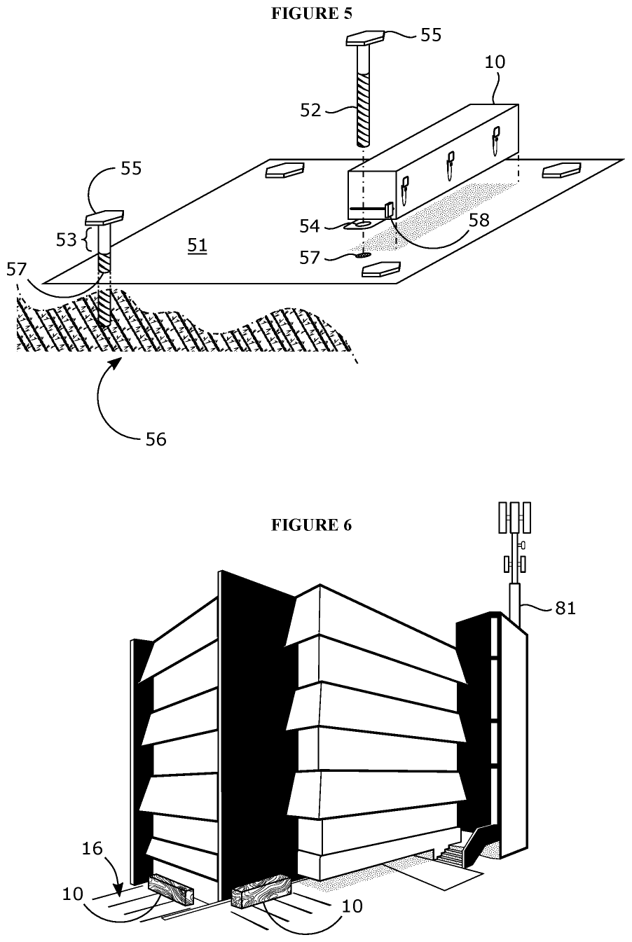

FIG. 6 depicts the installation of several charging devices (10) adjacent to parking spaces (16) at a business and showing a home base (81), which is a communication feature that allows for local communication with each of the charging devices (10) and then allowing for the home base (81) to communicate to the network. This allows for lower energy consumption for the charging device (10) which require only a local transmission and then allowing for the home base (81), which may simply be a remote computer having receiving and transmission capabilities to receive information for each of the charging devices (10) within proximity and relay their information to the network as a whole. This can allow for the updates on the capacity of each device, whether it is in use or free, and other information necessary for the system as a whole to function. A set of chargers in a location may use the home base (81), allowing a plurality of charging devices to communicate to the home base (81) and the home base then communicate with a backend server or other system for communication regarding status.

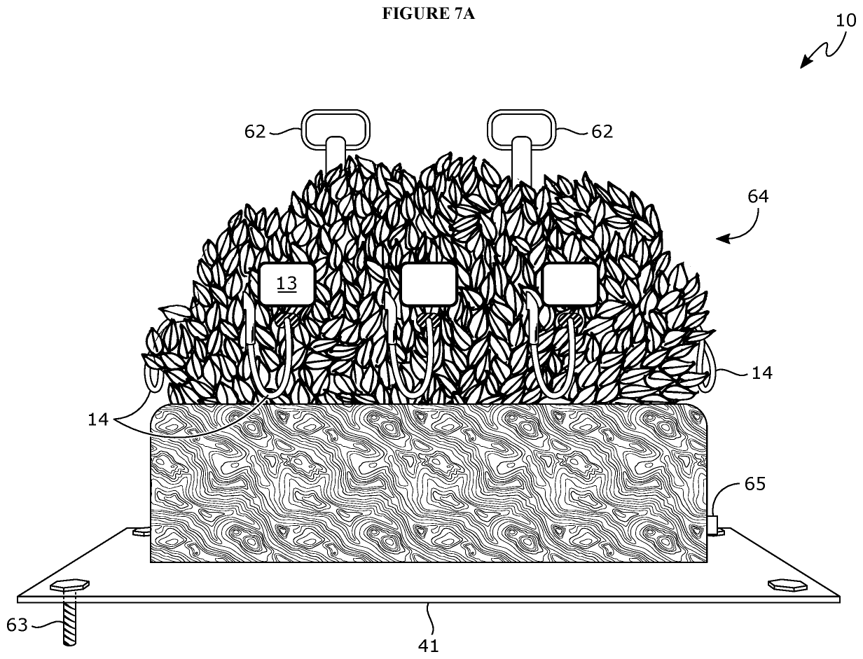

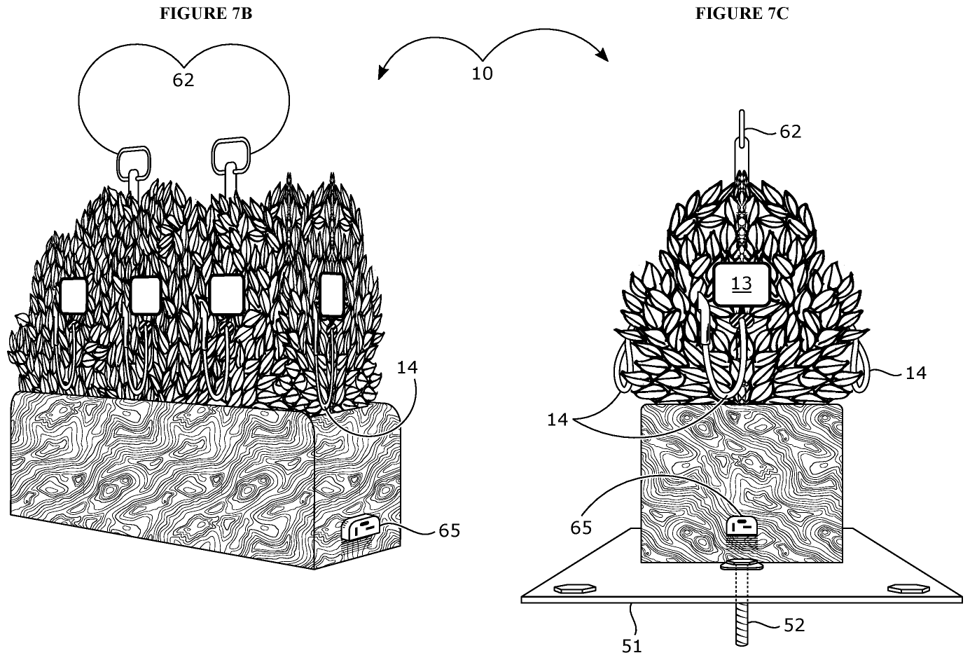

FIGS. 7A, 7B, and 7C depict a charging device (10) using a hedge visual (64), which provides a visual hedge to hide the charging device (10). A display unit (13), such as a touch screen device can identify to users the charging wire (14) and allow for users to select payment, select the speed of charge, and select the quantity of power to charge, among other features. Preferably, the display (13) whether alone or in concert with the controller (35) allows for communication with the user and the EV to be charged and the charging device (10). This allows for fast and easy payment and selection of the charging needs, as well as information such as time for completion and can allow for a variety of tools to allow communication back to the user when the EV is charged. For example, the display may allow for texting or calling of the user when the charge is completed, allowing the user to move onto other business while charging.

FIG. 7A depicts a charging port (65) which allows for the charging device (10) to be remotely charged by another power source. In FIG. 7A, the parking anchor (41) is depicted with a threaded fastener (63), which secures the parking anchor (41) to the ground. The charging device (10) can then be connected to the parking anchor (41) in any number of manners.

FIG. 7B depicts a charging device (10) without a base, meaning that the mass of the charging device (10) itself is sufficient for stability. For example, if the charging device (10) is to be placed on a blacktop and the owner does not want any damage to the blacktop, then such installation as in FIG. 7B can be utilized.

FIG. 7C then depicts the anchor plate (51) system wherein the threaded anchor (52) is installed to utilize a single threaded anchor (52) to secure the charging device (10) to the anchor plate (51), thus securing the charging device (10) to the location. In such installation, a specialty tool may allow for the installation even when the charging device (10) is full of batteries, or the installation can occur first and then the batteries stacked within the opening cavity of the support structure (18).

In each of FIGS. 7A, 7B, and 7C, a lifting anchor (62) is provided. This allows for the charging device (10) to be lifted and placed into its desired location. A crane truck, for example, can easily lift the charging device (10) to put it into place. Where the weight is too much, the charging device (10) can be placed empty and then batteries stacked into the void of the support structure as necessary. The lifting anchor may be connected to a battery support within the charging device (10). Thus, as depicted in FIG. 2 or 3, the batteries (31) or a stack of batteries (31a, 31b, and 31c) can be removed by elevating the lifting anchor (62) to clear the support structure (18). A preferred embodiment may utilize, for example, a crane truck that uses an actuating arm to lift out the spent batteries and replace a new battery or set of batteries into the support structure (18). A battery harness or other support structure may contain the batteries together to be removed as one unit. In certain embodiments, the lifting anchor (62) can be a threaded anchor (52), which thus can be both the lifting anchor (62) and also securing the device and/or base to the ground. In such a manner, the single element (lifting anchor [62]) can provide multiple features in the single element.

Each of the devices, when connected to an EV, will allow for charging of the battery of the EV. This can be accomplished at an appropriate rate as paid for by the user or as allowed by the capacity and type of electrical storage in the charging device (10) and as allowed by the battery of the EV to prevent damage. Each of the devices allows for wired communication, both with a vehicle, so it knows the type of vehicle and charging or is transmitted through wires when charging, as well as to the system as a whole, to identify the charge for a given charging device (10). This can be facilitated through the onboard controller (35).

Ports from the device allow for a discharge of the charge stored within the device, such as from a battery or capacitor or another device feature. The devices thus hold a charge and allow for a rapid discharge into the battery of the vehicle. The charging device may also use the stored charge for managing its electrical components or use a separate battery or power generation in order to operate.

The device preferably contains a GPS or other tracking unit to allow for a user to identify the location of a device and also whether it is free and ready to charge. Certain features also allow for a confirmation of the total charge in the device, as the device may have only a small amount of charge left before it needs to be replaced or recharged itself.

### Example

A user, desiring to charge an EV, finds a local hotel that has a charging device (10). The user accesses a Web site, which provides a GUI depicting the location of GPS-enabled charging devices (10). Each of the individual charging devices (10) being connected to a network identifies the location of the charging device (10). Using the Web site, the user identifies via the GUI, for example showing present location, and map/location-based points of the charging devices. The user's EV needs only 50 kW·h to charge fully or as needed by the user. The network identifies that the charging device has 100 kW·h of capacity for charging, thus being sufficient to charge the user's EV. The user drives to the location of the charging device, and the user pulls into a parking spot adjacent to the charging device (10) and plugs in the plug (15) to the EV. The charging device (10) recognizes the battery and the amount of capacity needed to fill the battery by accessing through the plug (15) data and information from the EV, which is communicated to the processor of the charging device. Software within the charging device then determines the amount, charge speed, and additional information needed for the charge. The user touches the display (13) and selects “fill,” and the system determines that 50.24 kW·h are necessary and provides a cost and time to complete. The user pays and the device can take a payment, such as through a credit card or other wireless or wired payment systems and the charging begins. The system allows for entry of a cell phone number, which will notify the user when the charging is done or automatically set a timer on the user's device. The charging stops and the user is notified by text from the system, and the user returns to the EV, unplugs the charger, and leaves, with the EV now at full charge or charged via the amount paid by the user. The user paid for the electricity in advance and no further payment is necessary at this time.

In a further example, as with the above, the charging device (10) communicates with a home base (81). The communication between the charging device (10) and the home base (81) may be via Bluetooth or other forms of communication suitable for the necessary speed and distance between the two devices. The home base (81) then communicates with the network to identify the charge left, the location of the charging device, whether it is in use or not, and other factors. In such a manner, the home base (81) can be wired, and communicate via low energy transmissions with a proximate charging device (10). This allows for heavier energy demands to be processed by the home base (81), allowing for the charging device (10) to retain as much energy as possible for charging of EV.

In preferred embodiments, the network, whether via a home base (81) or one or more charging devices (10) identifies that a charging device (10) is nearly out of power. This information is presented to a central server and ultimately communicated to a crane truck, which holds at least one charged battery. The crane truck drives to the location of the charging device (10) that is nearly out of power and replaces the battery with one charged battery. The system identifies that a batters is replaced and updates the amount of charge available at the particular charging device (10) to now show a different kW·h available to be accessed by an EV. In this manner, a plurality of charging devices (10) can be serviced by one or more crane trucks, and wherein continual replacement of empty or nearly empty batteries with those which are fully charged, allows for the system as a whole to remain operational. Thus, a plurality of charging devices (10) can have full or nearly fully charge, without being connected to a high-voltage power source, while still being able to rapidly charge an EV that accesses the charging device (10).

When a crane truck approaches a charging device (10) for replacement of a spent battery, a unique tool can be utilized to unlock a fastener (52) and then access the lifting anchor (62) or other feature to quickly remove the spent batteries. Lifting of the spent batteries and placing them on the crane truck and then replacing a new set of batteries into the charging device (10) allows for the charging device (10) to be rapidly “recharged” for operational purposes.

A further embodiment allows for the crane truck to have a large battery stored on the truck itself, likely to be several times of the capacity of the battery within the charging device (10). The crane truck can then plug into the charging device (10) such as through charging port (65) as depicted in FIG. 7A. This allows for charging of the batteries within the charging device by an outside source, instead of replacement of the batteries.

In a further example, the charging device communicates directly with the network to provide information as to the charge left, location, and whether in use or not. The system can be used by an individual user, who is seeking to charge an EV, or can be utilized by operators of the system, who are replacing spent batteries with ones having greater charge, in order to maintain the system's kW·h available to users.

The embodiments herein detail a new and useful device for charging of EVs. In particular, the embodiments detail solutions that allow for secure fastening of charging devices (10) into the environment, and which create minimal damage to underlying pavement or concrete. Furthermore, these embodiments allow for rapid deployment of stored power to EVs that need charging. Furthermore, the system including one or a plurality of charging devices can seamlessly communicate with users to identify the location of a charging device, identify the amount of charge present in the device, and to pay for and charge an EV. Further still, such systemwide information can be used by operators to recharge or replace batteries within the units to maintain optimal kW·h charge within the one or more charging devices of the system.

Those of ordinary skill in the art will recognize that the various features detailed herein can be combined with features described in a prior or subsequent feature to make the device or system operational. Furthermore, those of ordinary skill in the art will recognize that certain elements may be replaced with or modified without deviating from the scope of the present disclosure.

What is claimed is:

1. An electrified vehicle (EV) charging device comprising a support structure, said support structure defined to receive at least one electrical storage device within an opening in the support structure, said support structure further comprising a display unit and a charging wire, said charging wire configured for attaching to a port on an EV for providing charge from the electrical storage device to the EV.

2. The EV charging device of claim 1 wherein said support structure comprises an aesthetic exterior.

3. The EV charging device of claim 2 wherein the aesthetic exterior is selected from the group consisting of: a tree, a hedge, a vegetative display, and combinations thereof.

4. The EV charging device of claim 2 wherein the aesthetic exterior comprises a charging element selected from a photoelectric panel and a turbine.

5. The EV charging device of claim 1 further comprising a support base comprising an aperture.

6. The EV charging device of claim 5 further comprising wherein the support structure comprises a structure aperture which is aligned with the aperture within the support base, wherein the structure aperture and the aperture within the support base are configured to receive a fastener to secure said support base to a ground surface by having a head of the fastener on a first side of the aperture and a shaft portion of the fastener passing through both of the aperture within the support base and the structure aperture, said shaft portion to be received within a substrate below the support structure.

7. The EV charging device of claim 6 wherein the fastener comprises an anchor space which defines a space between the support base and a head of the fastener and wherein the structure aperture receives the head and secures the charging device to the support base.

8. The EV charging device of claim 7 further comprising a locking member positioned within the support base wherein the locking member is configured to engage to the fastener.

9. The EV charging device of claim 8 wherein the locking member is configured to engage to the head of the fastener.

10. The EV charging device of claim 1 further comprising a wireless connectivity element, a processor, and software sufficient to provide a connection between the EV charging device and a battery in an EV.

11. The EV charging device of claim 1 further comprising at least one fastener engaging to a base and to a ground surface, said EV charging device separately connected to said base.

12. The EV charging device of claim 1 comprising a base and a fastener, said base having a top side, a bottom side, and one aperture disposed of between said top side and said bottom side, said top side of said base contacting the EV charging device and the bottom side of the base in contact with a ground surface, wherein the aperture within the base aligns with a second aperture within the support structure, and wherein a single fastener is suitable for securing the EV charging device to said base and into a surface.

13. A system for charging an electrified vehicle (EV) with a wireless EV charging device, said wireless EV charging device comprising:
a. at least one battery, a housing surrounding the at least one battery, a wireless transceiver, and a processor suitable for operating software and the wireless transceiver;
b. said wireless EV charging device having a known GPS location and defining a kilowatt-hours of electricity stored within the at least one battery;
c. a network, said network defining the GPS location of said wireless EV charging device;
d. the network defining the total amount of charge remaining within the system at the wireless EV charging device at the particular GPS location; and
e. the system operating said software to perform the following steps:
i. receiving a request for a charge of an EV;
ii. defining the amount of charge desired for the EV;
iii. identifying the closest wireless EV charging device having the charging capacity for the EV; and
iv. providing a GPS location for the wireless EV charging device having capacity for the EV.

14. The system of claim 13 further comprising transmitting stored power from the EV charging device to the EV.

15. An electrified vehicle (EV) charging device, said EV charging device comprising:
a support structure having a void defined therein;
at least one battery positioned within the void;
the support structure having a base end and a top end;
a decorative feature positioned on said top end and a support base positioned on said base end; and
a lifting anchor configured to the at least one battery.

16. The EV charging device of claim 15 wherein the lifting anchor comprises a threaded fastener at one end.

17. The EV charging device of claim 15 wherein the lifting anchor is defined with a threaded fastener at one end of the lifting anchor.

18. The EV charging device of claim 17 wherein the threaded fastener passes through an aperture within the support base.

19. The EV charging device of claim 18 wherein removal of the at least one battery is defined by rotating the threaded fastener.

20. The EV charging device of claim 18 wherein removal of the at least one battery is performed by rotating the at least one lifting anchor, removing the at least one battery, and replacing the at least one battery with a second battery.
